(19) United States
(12) Patent Application Publication
(10) Pub. No.: US 2023/0132561 A1
(43) Pub. Date: May 4, 2023

(54) HAND TOOL

(71) Applicant: KABO TOOL COMPANY, Taichung City (TW)

(72) Inventor: Chih-Ching HSIEH, Taichung City (TW)

(21) Appl. No.: 18/050,052

(22) Filed: Oct. 27, 2022

Related U.S. Application Data
(60) Provisional application No. 63/263,384, filed on Nov. 1, 2021.

(51) Int. Cl. B25B 23/10; B25B 13/08

(52) U.S. Cl. CPC B25B 23/10; B25B 13/08

(57) ABSTRACT

A hand tool includes a handle, at least one driving head, at least one groove and at least one abutting element. The at least one driving head is connected with at least one end of the handle. The at least one groove is disposed on an inner edge of the at least one driving head, and includes an inner wall and at least one margin structure. The at least one margin structure extends from an end of the inner wall, and an angle is between the at least one margin structure and the inner wall. The at least one abutting element is disposed on the at least one groove.

### RELATED APPLICATIONS

This application claims priority to U.S. Provisional Application Serial Number 63/263,384, filed Nov. 01, 2021, which is herein incorporated by reference.

### BACKGROUND

### Technical Field

The present disclosure relates to a tool. More particularly, the present disclosure relates to a hand tool.

### Description of Related Art

Hand tools are widely used in industries or our daily life, and are usually applied to install or remove parts for different purposes. To enable a hand tool to cooperate with parts of different types, sizes, and styles, an abutting element is configured in the driving head of the conventional hand tool to adapt to different parts. However, how to enable the abutting element to fit tightly with the parts and to smoothly remove the parts from the hand tool after the operation is completed is a problem that the relevant industry is eager to solve.

### SUMMARY

According to one aspect of the present disclosure, a hand tool includes a handle, at least one driving head, at least one groove and at least one abutting element. The driving head is connected with at least one end of the handle. The groove is disposed on an inner edge of the driving head, and includes an inner wall and at least one margin structure. The margin structure extends from an end of the inner wall, and an angle is between the margin structure and the inner wall. The abutting element is disposed on the at least one groove.

### BRIEF DESCRIPTION OF THE DRAWINGS

The present disclosure can be more fully understood by reading the following detailed description of the embodiment, with reference made to the accompanying drawings as follows:

FIG. 1 is an exploded view of a hand tool according to one embodiment of the present disclosure.

FIG. 2 is a partially exploded view of the hand tool according to the embodiment in FIG. 1.

FIG. 3 is a partially cross-sectional view of the hand tool according to the embodiment in FIG. 1.

FIG. 4 is a three-dimensional view showing a connection between the hand tool and a to-be-operated object according to the embodiment in FIG. 1.

FIG. 5 is a three-dimensional view of a driving head of a hand tool according to another embodiment of the present disclosure.

FIG. 6 is a cross-sectional view and a partially enlarged view of the driving head according to the embodiment in FIG. 5.

FIG. 7 is a partially enlarged view of a groove of a hand tool according to further another embodiment of the present disclosure.

FIG. 8 is a partially enlarged view of a groove of a hand tool according to still another embodiment of the present disclosure.

FIG. 9 is a partially enlarged view of a groove of a hand tool according to yet another embodiment of the present disclosure.

FIG. 10 is a partially enlarged view of a groove of a hand tool according to another embodiment of the present disclosure.

### DETAILED DESCRIPTION

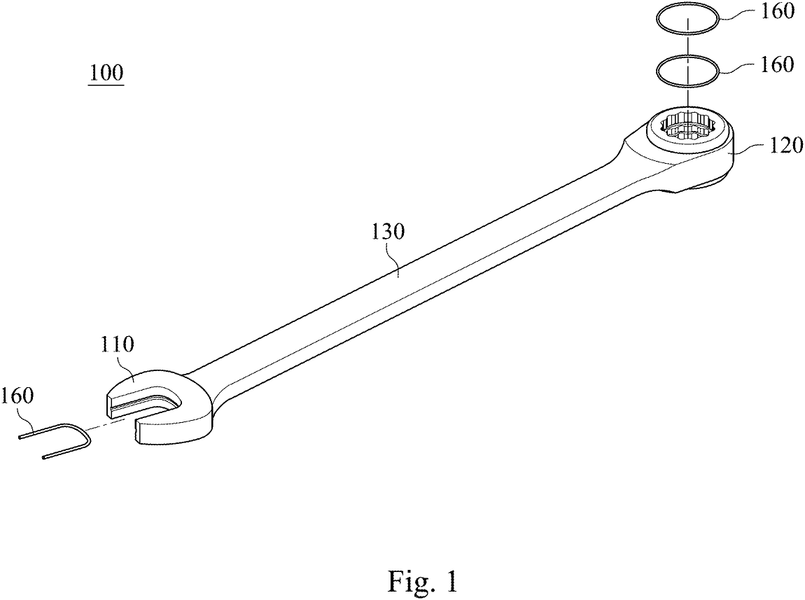

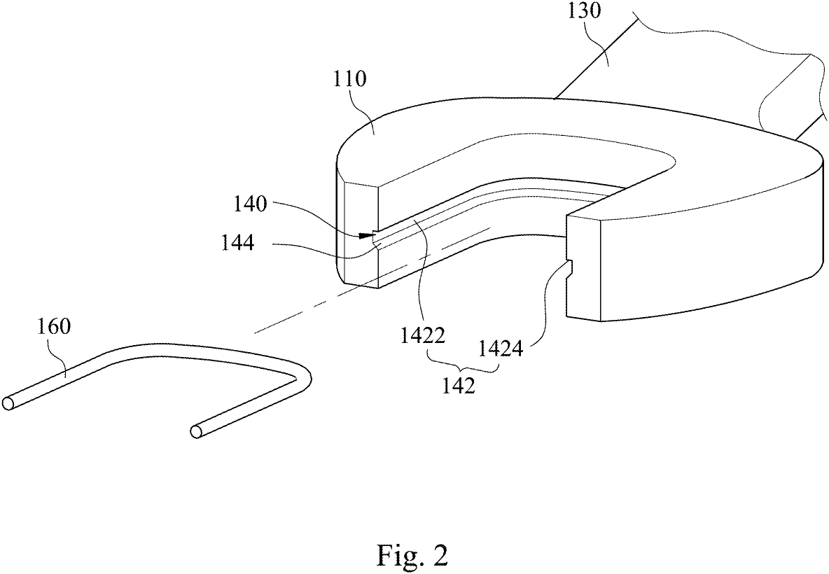

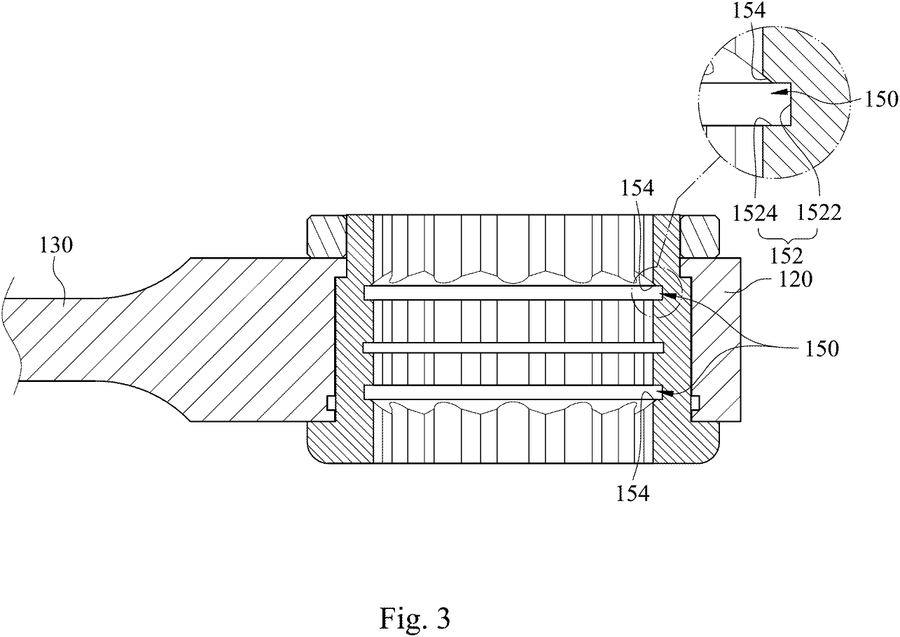

Please refer to FIG. 1. FIG. 1 is an exploded view of a hand tool 100 according to one embodiment of the present disclosure. In FIG. 1, the hand tool 100 includes two driving heads 110 and 120, a handle 130, a plurality of grooves 140 and 150 (whose reference numerals are shown in FIG. 2 and FIG. 3, respectively) and a plurality of abutting elements 160. The driving heads 110 and 120 are connected to two ends of handle 130, respectively, and shape of handle 130 is a flat rod.

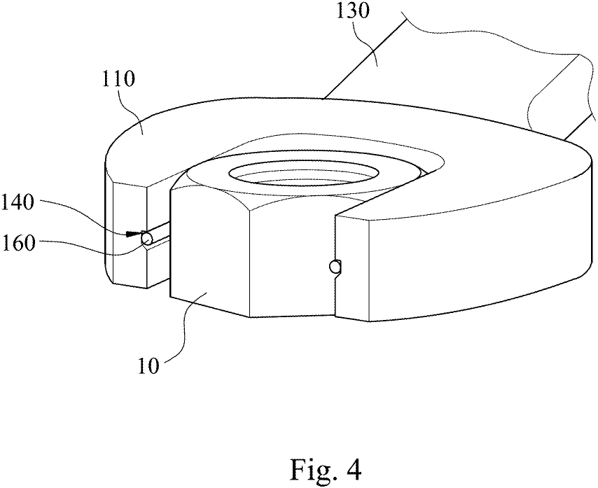

Please refer to FIG. 2. FIG. 2 is a partially exploded view of the hand tool 100 according to the embodiment in FIG. 1. The driving head 110 of the hand tool 100 is an open-ended wrench structure, and the hand tool 100 can connect to a to-be-operated object 10 (as shown in FIG. 4) through the driving head 110. The groove 140 is disposed on an inner edge of the driving head 110, and the groove 140 includes an inner wall 142 and a margin structure 144. The margin structure 144 extends from an end of the inner wall 142, and an angle is between the margin structure 144 and the inner wall 142. The abutting element 160 is disposed on the groove 140. In detail, the shape of the abutting element 160 generally corresponds to the shape of the groove 140, so that the abutting element 160 is partially disposed on the groove 140 along the shape of the groove 140.

In detail, in FIG. 2, the inner wall 142 includes a bottom surface 1422 and a side surface 1424. The bottom surface 1422 is planar, the side surface 1424 extends vertically from an end of the bottom surface 1422, wherein the margin structure 144 is an inclined surface and extends from the other end of the bottom surface 1422; so that a cross-section of the groove 140 is trapezoidal.

Please refer to FIG. 3. FIG. 3 is a partially cross-sectional view of the hand tool 100 according to the embodiment in FIG. 1. The driving head 120 of the hand tool 100 is a ratchet structure, and the hand tool 100 can connect to the to-be-operated object through the driving head 120. Two grooves 150 are disposed on an inner edge of the driving head 120. Each of the grooves 150 includes an inner wall 152 and a margin structure 154. The margin structure 154 extends from an end of the inner wall 152, and an angle is between the margin structure 154 and the inner wall 152. Two abutting elements 160 are disposed on the two grooves 150, respectively. In detail, a shape of each of the abutting elements 160 generally corresponds to a shape of each of the grooves 150, so that each of the abutting elements 160 is partially disposed on each of the grooves 150 along the shape thereof.

In detail, in FIG. 3, the inner wall 152 includes a bottom surface 1522 and two side surfaces 1524. The bottom surface 1522 is a planar surface, each of the two side surfaces 1524 extends vertically from each of two ends of the bottom surface 1522, and the margin structure 154 extends away from an end of the bottom surface 1522 from one of the side surfaces 1524. The margin structure 154 is an inclined surface, and an angle is between the margin structure 154 and the side surface 1524.

In FIG. 1 to FIG. 3, the hand tool 100 includes two driving heads 110, 120, but in other embodiments, the number of the driving head of the hand tool can be one, and the driving head connects to one end of the handle. Furthermore, in the embodiment in FIG. 1 to FIG. 3, one abutting element 160 and one groove 140 are disposed on the driving head 110, and the groove 140 includes one margin structure 144. Two grooves 150 and two abutting elements 160 are disposed on the driving head 120, and each of the grooves 150 includes one margin structure 154. But in other embodiments, the number of the grooves and the abutting elements disposed on the driving head can be different, and the grooves can include a different number of the margin structures.

The operation method and the operation principle of the hand tool 100 are described below through the driving head 110. FIG. 4 is a three-dimensional view showing a connection between the hand tool 100 and the to-be-operated object 10 according to the embodiment in FIG. 1. Only the case that the driving head 110 is mounted on the to-be-operated object 10 will be shown and described herein, and the case that the driving head 120 is mounted on the to-be-operated object 10 is similar. When a user would like to drive the to-be-operated object 10, the driving head 110 can be mounted on the to-be-operated object 10. A part of the abutting element 160 outside the groove 140 is pressed by the to-be-operated object 10, so that the abutting element 160 is pushed toward the margin structure 144 and deformed. The abutting element 160 then generates a restoring force to fasten the to-be-operated object 10. When the user exerts a force on the handle 130, the user can exert a torque on the to-be-operated object 10 through a friction force between the abutting element 160 and the to-be-operated object 10 so as to drive the to-be-operated object 10.

In the conventional hand tool, there is no margin structure being disposed thereon, which means that the turning angles of the inner wall of the groove are all right angles. When the abutting element is pressed by the to-be-operated object, there is no extra space for the abutting element to move, thus the abutting element is deformed and exerts a greater force on the to-be-operated object, so that the to-be-operated object is fixed too tightly to be removed. With a configuration of the margin structure 144, the margin structure 144 extends from the end of the inner wall 142, the angle is between the margin structure 144 and the inner wall 142, and the margin structure 144 forms an outer space that enables the abutting element 160 to move, so that the to-be-operated object 10 can be removed easily from the driving head 110 of the hand tool 100.

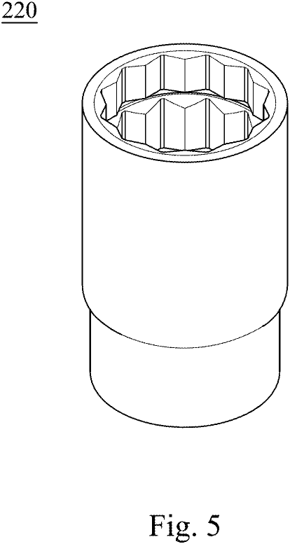

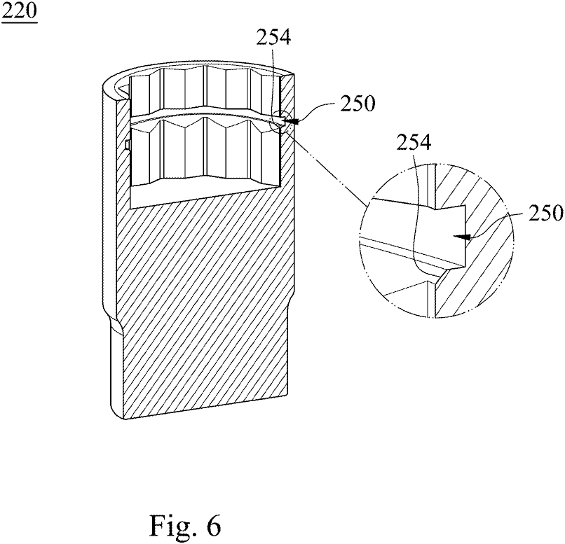

Please refer to FIG. 5 and FIG. 6. FIG. 5 is a three-dimensional view of a driving head 220 of a hand tool according to another embodiment of the present disclosure. FIG. 6 is a cross-sectional view and a partially enlarged view of the driving head 220 according to the embodiment in FIG. 5. The driving head 220 of the hand tool of the embodiment in FIG. 5 is similar with the driving head 120 of the hand tool 100 of the embodiment in FIG. 1, which is also a ratchet structure, but the driving head 220 only includes a groove 250 disposed on an inner edge of the driving head 220. The difference between the driving head 220 and the driving head 120 is that there is an opening on each side of the driving head 120 for mounting the to-be-operated object 10, but the driving head 220 being cylindrical only has one opening on one side. Since the shape, the configuration, and the operation principle of the groove 250 and the margin structure 254 are the same as the shape, the configuration, and the operation principle of each of the grooves 150 and the margin structure 154, the same technical features will not be repeated herein.

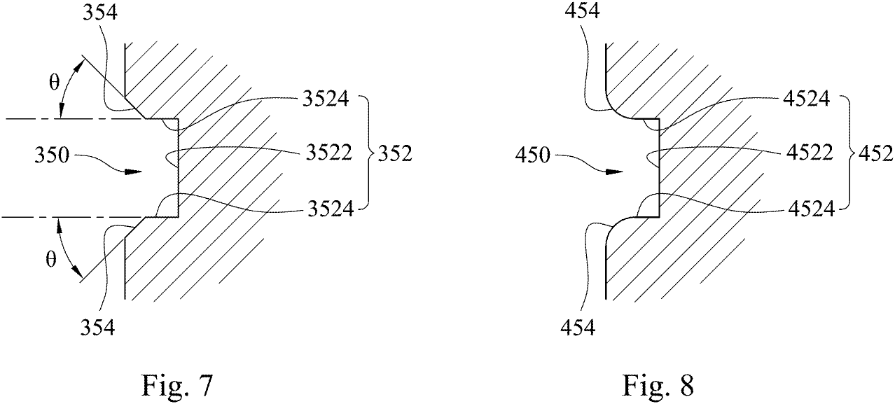

The grooves of other embodiments of the present disclosure are described below. Please refer to FIG. 7. FIG. 7 is a partially enlarged view of a groove 350 of a hand tool according to further another embodiment of the present disclosure. In FIG. 7, a number of margin structures 354 of the groove 350 is two, the two margin structures 354 extend from two ends of an inner wall 352, respectively. In detail, the inner wall 352 includes a bottom surface 3522 and two side surfaces 3524, the bottom surface 3522 is a planar surface, the two side surfaces 3524 extend vertically from two ends of the bottom surface 3522, and each of the two margin structures 354 extend away from an end of the bottom surface 3522 from each of the two side surfaces 3524. Each of angles between each of the margin structures 354 and each of the side surfaces 3524 is θ, and the following condition is satisfied: 15° ≦ θ ≦ 70°.

Please refer to FIG. 8. FIG. 8 is a partially enlarged view of a groove 450 of a hand tool according to still another embodiment of the present disclosure. In FIG. 8, a number of margin structures 454 of the groove 450 is two, and the two margin structures 454 are curved surfaces and extend from two ends of an inner wall 452, respectively. In detail, the inner wall 452 includes a bottom surface 4522 and two side surfaces 4524, the bottom surface 4522 is a planar surface, the two side surfaces 4524 extend vertically from two ends of the bottom surface 4522, and each of the two margin structures 454 extends away from an end of the bottom surface 4522 from each of the two side surfaces 4524.

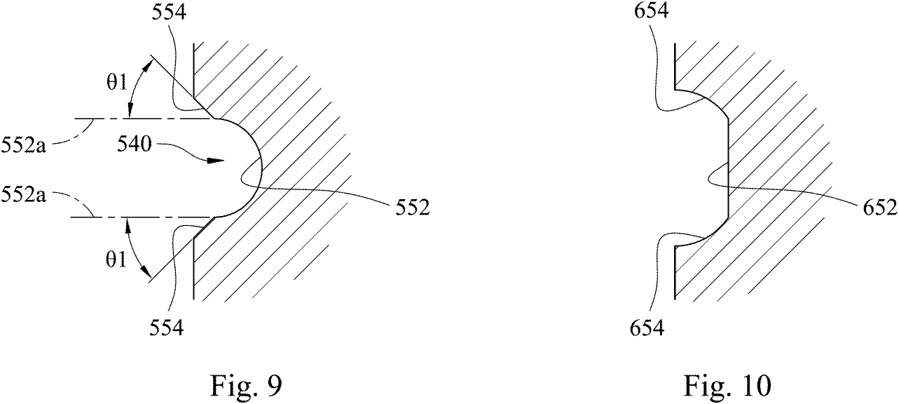

Please refer to FIG. 9. FIG. 9 is a partially enlarged view of a groove 550 of a hand tool according to yet another embodiment of the present disclosure. In FIG. 9, a number of margin structures 554 of the groove 550 is two, each of the two margin structures 554 is a inclined surface, an inner wall 552 is a curved wall, and the two margin structures 554 extend from two ends of the inner wall 552, respectively. An angle between the inner wall 552 and each of the margin structures 554 is θ1, and the following condition is satisfied: 15 ° ≦ θ1 ≦ 70 °. Each of the angles θ1 can be defined as the angle between each of virtual planes 552a and the margin structures 554, wherein the two virtual planes 552a are extended from two ends of the inner wall 552 which is a curved-shape (it should be mentioned that the virtual planes 552a are shown to elaborate more clearly and are not real structures).

Please refer to FIG. 10. FIG. 10 is a partially enlarged view of a groove 650 of a hand tool according to another embodiment of the present disclosure. In FIG. 10, a number of margin structures 654 of the groove 650 is two, each of the two margin structures 654 is a curved surface, an inner wall 652 is a planar wall, and the two margin structures 654 extend from two ends of the inner wall 652, respectively. Since the operation methods and the operation principles of the hand tools in FIG. 7 to FIG. 10 are the same as the operation methods and the operation principles of the hand tool 100 in FIG. 1 to FIG. 4, the same technical features will not be repeated herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A hand tool, comprising:
a handle;
at least one driving head connected with at least one end of the handle;
at least one groove disposed on an inner edge of the at least one driving head, the at least one groove comprising:
an inner wall; and
at least one margin structure extending from an end of the inner wall, an angle being between the at least one margin structure and the inner wall; and
at least one abutting element disposed on the at least one groove.

2. The hand tool of claim 1, wherein a number of the at least one margin structure is two, and each of the two margin structures extends from the end and the other end of the inner wall.

3. The hand tool of claim 1, wherein the inner wall is a curved wall.

4. The hand tool of claim 3, wherein the angle between the inner wall and the at least one margin structure is θ1, and the following condition is satisfied:
15° ≤ θ1 ≤ 70°.

5. The hand tool of claim 1, wherein the inner wall is a planar wall.

6. The hand tool of claim 1, wherein the inner wall comprises:
a bottom surface; and
at least one side surface extending vertically from an end of the bottom surface, wherein the at least one margin structure extends away from an end of the bottom surface from the at least one side surface.

7. The hand tool of claim 6, wherein the at least one margin structure is an inclined surface.

8. The hand tool of claim 7, wherein an angle between the at least one margin structure and the at least one side surface is θ, and the following condition is satisfied:
15° ≤ θ ≤ 70°.

9. The hand tool of claim 1, wherein the at least one margin structure is an inclined surface or a curved surface.

10. The hand tool of claim 1, wherein each of a number of the at least one groove and a number of the at least one abutting element is larger than or equal to two.
